(19) United States
(12) Patent Application Publication
(10) Pub. No.: US 2005/0213471 A1
(43) Pub. Date: Sep. 29, 2005

(54) Reflecting optical element and optical pickup device

(75) Inventors: Tomokazu Taguchi, Osaka (JP); Kazuyuki Nishi, Osaka (JP); Koji Takahara, Osaka (JP); Takuji Hatano, Osaka (JP)

Correspondence Address: BRINKS HOFER GILSON & LIONE, P.O. BOX 10395, CHICAGO, IL, 60610, US

(73) Assignee: KONICA MINOLTA OPTO, INC.

(21) Appl. No.: 11/081,116

(22) Filed: Mar. 16, 2005

(30) Foreign Application Priority Data
Mar. 25, 2004 (JP) 2004-90077
Apr. 13, 2004 (JP) 2004-117562

(51) Int. Cl. G11B 7/00

(52) U.S. Cl. 369/109.02

(57) ABSTRACT

A reflecting optical element has a phase difference adjusting reflective film, which is formed on an interface between a medium optically denser than air and air and reflects light in the medium. The phase difference adjusting reflective film reflects incident light with a predetermined wavelength without substantially changing a phase difference between polarized light components of the incident light perpendicular to each other.

This application is based on the following Japanese Patent Applications, the entire contents of which are hereby incorporated by references:
Japanese Patent Application No. 2004-90077 (filed in Japan Mar. 25, 2004), and
Japanese Patent Application No. 2004-117562 (filed in Japan Apr. 13, 2004).

### BACKGROUND OF THE INVENTION

1. Field of the Invention

The present invention relates to a reflecting optical element having a phase difference adjusting reflective film which is capable of controlling a polarized state of reflected light. Further, the present invention relates to an optical pickup device having the reflecting optical element.

2. Description of the Related Art

Conventionally, as reflecting optical elements, metal reflective mirrors deposited with a metal film (for example, aluminum or silver), and dielectric reflective mirrors deposited with multilayered dielectric film are known.

When polarized light flux enters the metal reflective mirror or the dielectric reflective mirror, a phase difference occurs between P polarized light and S polarized light, and the polarized state is changed. For example, linearly polarized light is changed into elliptically polarized light. When, therefore, such a reflective mirror is used in optical devices utilizing polarized light, desired characteristics cannot be obtained because of the change in the polarized state.

In the case of the dielectric mirrors, a film thickness and film materials are contrived so that the phase difference can be suppressed on a certain specified wavelength, but very large number of layers are required. Further, it is very difficult to prevent the occurrence of the phase difference on a plurality of wavelengths.

A change in reflectance of the metal reflective mirrors according to wavelengths is small, but high reflectance cannot be obtained. In the case of the dielectric reflective mirrors, in order to obtain high reflectance on a plurality of wavelengths, a very large number of layers are required. It is very difficult to combine high reflectance and phase compensation.

### SUMMARY OF THE INVENTION

It is an object of the present invention to easily provide a reflecting optical element having a reflective film which has high reflectance and prevents occurrence of a phase difference. It is another object of the present invention to easily provide a reflecting optical element which has a reflective film having high reflectance and capable of controlling a phase difference on plural wavelengths. It is still another object of the present invention to provide an optical pickup device having these reflecting optical elements.

To achieve the above object, according to first aspect of the present invention, a reflecting optical element is provided with a phase difference adjusting reflective film formed on an interface between a medium optically denser than air and air and reflecting light in the medium. The phase difference adjusting reflective film reflects light having a predetermined wavelength without substantially changing a phase difference between polarized components perpendicular to each other.

According to second aspect of the present invention, a reflecting optical element is provide with a phase difference adjusting reflective film formed on an interface between a medium optically denser than air and air and reflecting light in the medium. Two or more light having different wavelengths enter the reflecting optical element and the phase difference adjusting reflective film reflects a first light with a first wavelength without substantially changing a polarized state thereof, and reflects a second light with a second wavelength so that its polarized state substantially becomes the same as the polarized state of the first light.

According to third aspect of the present invention, an optical pickup device is provide with a light source that emits a light; and a reflecting optical element that reflects the light from the light source so that an optical path is bent. The reflecting optical element has a phase difference adjusting reflective film is formed on an interface between a medium optically denser than air and air and reflects the light in the medium. The phase difference adjusting reflective film reflects the light having a predetermined wavelength without substantially changing a phase difference between polarized components perpendicular to each other.

According to forth aspect of the present invention, an optical pickup device is provide with at least two light sources emitting lights having a different wavelength, respectively and a reflecting optical element having a phase difference adjusting reflective film formed on an interface between a medium optically denser than air and air. The phase difference adjusting reflective film reflects the lights in the medium. The phase difference adjusting reflective film reflects a first light with a first wavelength without substantially changing a polarized state of the first light, and reflects a second light with a second wavelength so that a polarized state of the second light substantially becomes the same as the polarized state of the first light.

### BRIEF DESCRIPTION OF THE DRAWINGS

These and other objects, advantages and features of the invention will become apparent from the following description thereof taken in conjunction with the preferred embodiments with the reference to the accompanying drawings in which:

FIG. 1A is a top view illustrating a schematic constitution of an optical pickup device according to a first embodiment of the present invention;

FIG. 1B is a side view illustrating the schematic constitution of the optical pickup device according to the first embodiment of the present invention;

FIG. 2 is a diagram illustrating a reflecting optical element according to one embodiment of the present invention;

FIG. 3A is a top view illustrating a schematic constitution of the optical pickup device according to a second embodiment of the present invention;

FIG. 3B is a side view illustrating the schematic constitution of the optical pickup device according to the second embodiment of the present invention;

FIG. 4 is a graph illustrating reflection characteristics (incident angle: 43°) of a phase difference adjusting reflective film according to an example 1;

FIG. 5 is a graph illustrating reflection characteristics (incident angle: 45°) of the phase difference adjusting reflective film according to the example 1;

FIG. 6 is a graph illustrating reflection characteristics (incident angle: 47°) of the phase difference adjusting reflective film according to the example 1;

FIG. 7 is a graph illustrating phase difference characteristics of the phase difference adjusting reflective film according to the example 1;

FIG. 8 is a graph illustrating reflection characteristics (incident angle: 43°) of the phase difference adjusting reflective film according to an example 2;

FIG. 9 is a graph illustrating reflection characteristics (incident angle: 45°) of the phase difference adjusting reflective film according to the example 2;

FIG. 10 is a graph illustrating reflection characteristics (incident angle: 47°) of the phase difference adjusting reflective film according to the example 2;

FIG. 11 is a graph illustrating phase difference characteristics of the phase difference adjusting reflective film according to the example 2;

FIG. 12 is a graph illustrating reflection characteristics (incident angle: 45°) of the phase difference adjusting reflective film according to an example 3;

FIG. 13 is a graph illustrating phase difference characteristics (incident angle: 45°) of the phase difference adjusting reflective film according to the example 3;

FIG. 14 is a diagram illustrating the reflecting optical element according to a comparative example;

FIG. 15 is a graph illustrating reflection characteristics (incident angle: 45°) of the phase difference adjusting reflective film according to the comparative example; and

FIG. 16 is a graph illustrating phase difference characteristics (incident angle: 45°) of the phase difference adjusting reflective film according to the comparative example.

### DETAILED DESCRIPTION OF THE PREFERRED EMBODIMENTS

Embodiments of the present invention are explained below with reference to the drawings.

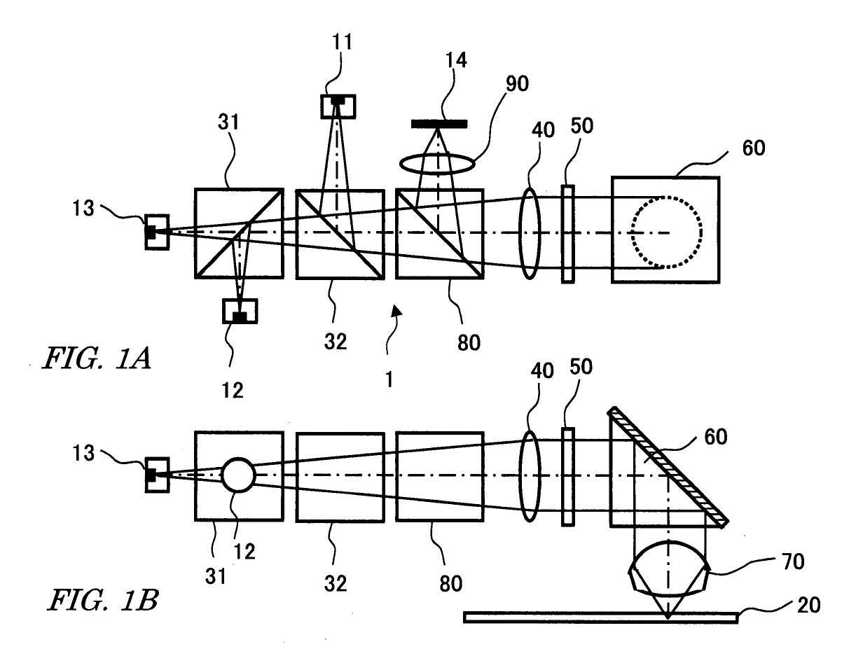

FIGS. 1A and 1B are diagrams illustrating a schematic constitution of an optical pickup device 1 according to a first embodiment. FIG. 1A is a top view of the optical pickup device 1, and FIG. 1B is a side view illustrating the optical pickup device 1. The optical pickup device 1 is a device that records information in an optical disc as an optical information recording medium and/or reproduces information from the optical disc. The optical disc 20 includes three kinds of optical discs: a first optical disc in which a transparent substrate has a thickness of t1 (for example, a next-generation high density optical disc using blue laser); a second optical disc (for example, DVD); and a third optical disc in which a transparent substrate has a thickness of t2 different from t1 (for example, CD). The thicknesses t1 and t2 of the transparent substrates are 0.6 mm and 1.2 mm, respectively. The first optical discs using blue laser may be a disc in which a transparent substrate has a thickness of t3 (for example, 0.1 mm) different from t1.

The optical pickup device 1 has a first semiconductor laser 11 as a first light source, a second semiconductor laser 12 as a second light source, and a third semiconductor laser 13 as a third light source. The first semiconductor laser 11 emits linearly polarized light with a first wavelength λ1 (395 nm≦λ1≦425 nm), the second semiconductor laser 12 emits linearly polarized light with a second wavelength λ2 (630 nm≦λ2≦690 nm), and the third semiconductor laser 13 emits linearly polarized light with a third wavelength λ3 (740 nm≦λ3≦870 nm). The first, the second and the third light sources are selected according to types of the optical discs in and/or from which information is recorded and/or reproduced.

The light sources 11, 12 and 13, combiners 31 and 32, a polarization beam splitter 80, a collimating lens 40, a ¼ wavelength plate 50, a photodetector 14, toric lens 90 and a reflecting optical element 60 of the optical pickup device 1 are arranged on a plane parallel with an information recording surface of the optical disc 20. As a result, the optical pickup device 1 is thinned.

An operation for reproducing information in the order of an optical path is explained simply below. Emitted light flux of the linearly polarized light emitted from the first semiconductor laser 11, the second semiconductor laser 12 or the third semiconductor laser 13 enters the collimating lens 40 via the beam combiners 31 and 32 and the polarization beam splitter 80 so as to be converted into parallel light. The beam combiners 31 and 32 combine optical paths from the light sources 11, 12 and 13 into one optical path. The parallel light as the linearly polarized light is converted into circularly polarized light by the ¼ wavelength plate 50. The ¼ wavelength plate 50 serves as a ¼ wavelength plate for the three wavelengths λ1, λ2 and λ3. For example, the ¼ wavelength plate 50 is constituted so that a plurality of phase plates are laminated slantingly in a manner that its optical axis makes a predetermined angle. As to the parallel light which transmits through the ¼ wavelength plate 50, its optical path is bent at 90° by the reflecting optical element 60, and the parallel light enters an objective lens 70. The light which enters the objective lens 70 is condensed on the information recording surface of the optical disc 20, and a beam spot is formed. A diffraction optical element is provided on a lens surface of the objective lens 70, and optical power of the objective lens 70 varies with the wavelengths. As a result, a spot position (optical axial direction) according to the thickness of the transparent substrate of the optical disc 20 can be obtained.

The reflecting optical element 60 is used in order to decrease the thickness of the optical pickup device 1 in the optical axial direction of the objective lens. That is to say, the reflecting optical element 60 bends the optical path at right angle, so that the light sources 11, 12 and 13, the combiners 31 and 32, the polarization beam splitter 80, the collimating lens 40, the ¼ wavelength plate 50, the photodetector 14, the reflecting optical element 60 and the like can be arranged on the plane vertical to the optical axis of the objective lens 70 (the plane parallel with the recording surface of the optical disc 20). As a result, the optical pickup device 1 can be thinned.

Incident light from the light sources to the optical disc 20 becomes reflected light which is modulated by information pits on the information recording surface, and it traces the reverse optical path to that of the incident light. The reflected light as the circularly polarized light is converted into linearly polarized light which is perpendicular to the laser emitted light by the ¼ wavelength plate 50. The reflected light is reflected by the polarization beam splitter 80, and enters the common optical detector 14 via the toric lens 90 so as to be detected as a signal.

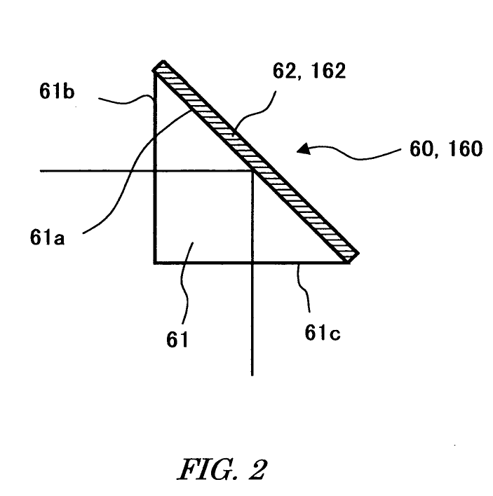

When the signal light is reflected by the polarization beam splitter 80, if the polarized state deviates from the linearly polarized light, the strength of the signal light to the photodetector 14 becomes weak, thereby deteriorating detecting accuracy. Return light to the laser is generated, and oscillation of the laser is made to be unstable. In order to reduce the influence of deviation of the polarized light due to the optical disc 20, the spot is formed on the optical disc 20 by the circular polarized light. Further, in order to bend the optical path, not a general reflective mirror but the reflecting optical element 60 is used. FIG. 2 illustrates the reflecting optical element 60.

In the reflecting optical element 60 which bends the optical path, a phase difference adjusting reflective film 62 is deposited on a reflective surface 61a of a prism 61. In general, when light enters an interface with different refractive index, the reflectance and the phase difference between the P polarized light and the S polarized light with respect to its incident surface change, and thereby changing the polarized state. Particularly like this embodiment, when the incident angle is 45° which is large, the influence is large. In the embodiment, the phase difference adjusting reflective film 62 is deposited on the reflective surface 61a, and thus a phase difference is prevented from occurring between the polarized light components which are perpendicular to each other with respect to the light beams with the first, the second and the third wavelengths. Since the polarized state does not change due to the reflection, the circularly polarized light enters the optical disc 20. Further, the signal light (return path) which transmits through the ¼ wavelength plate 50 is converted into linearly polarized light.

Although reflectance of the light beams with the three wavelengths from a conventional dielectric reflective mirror can be heightened, it is very difficult to simultaneously prevent a phase difference between even two different wavelengths. Even if a number of layers is increased, the occurrence of a phase difference cannot be prevented. The phase difference adjusting reflective film 62 according to the embodiment is provided onto an interface between an optically dense medium (prism medium, for example, glass) and an optically non-dense medium (air), and light is reflected in the prism medium. As a result, the occurrence of the phase difference among the light with plural wavelengths can be prevented.

An antireflective film which copes with the three wavelengths λ1, λ2 and λ3 is deposited on an incident surface 61b and an emission surface 61c of the prism 61, so as to prevent noises due to loss of light amount and the reflected light. Further, the incident surface 61b and the emission surface 61c are vertical to the optical axis, and this prevents the occurrence of astigmatism. Since the light enters the antireflective film vertically, the antireflective film prevents the phase difference.

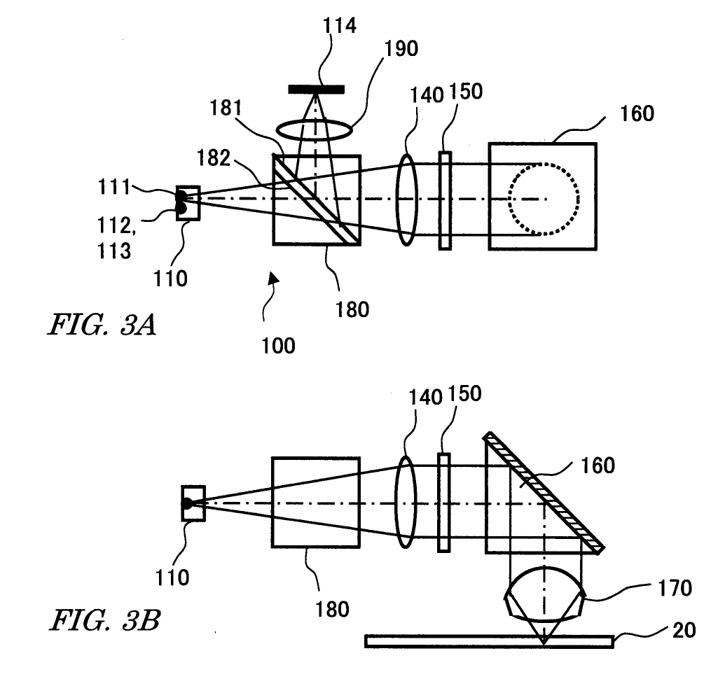

FIGS. 3A and 3B are diagrams illustrating a schematic constitution of an optical pickup device 100 according to a second embodiment. FIG. 3A is a top view of the optical pickup device 100, and FIG. 3B is a side view of the optical pickup device 100.

The optical pickup device 100 has a first semiconductor laser 111 (first wavelength λ1=405 nm) as a first light source, a second semiconductor laser 112 (second wavelength λ2=660 nm) as a second light source, and a third semiconductor laser 113 (third wavelength λ3=780 nm) as a third light source. The first, the second and the third light sources are constituted integrally as a single light source unit 110, and a radiant point of the second light source is substantially the same as a radiant point of the third light source. A position of a radiant point of the first light source is slightly different from the positions of the radiant points of the second and the third light sources (for example, 0.5 mm). The first, the second, and the third light sources are selected according to types of optical discs in and/or from which information is recorded and/or reproduced. FIGS. 3A and 3B illustrate the optical path of the light flux emitted from the first light source, and the light flux from the second and the third light sources is omitted in order to avoid the complication of the drawings.

The light source unit 110, the polarization beam splitter 180, the ¼ wavelength plate 150, the photodetector 114, the toric lens 190, and the reflecting optical element 160 are arranged on the plane parallel with the information recording surface of the optical disc 20, and the height of the optical pickup device 100 is reduced.

An operation for reproducing information in the order of the optical path is explained below. Emitted light flux of linearly polarized light emitted from the first semiconductor laser 111, the second semiconductor laser 112 or the third semiconductor laser 113 enters the collimating lens 140 via the polarization beam splitter 180 so as to be converted into parallel light. The polarized state of the parallel light as the linearly polarized light is converted by the ¼ wavelength plate 150. The ¼ wavelength plate 150 gives a phase difference of 90° to polarized light components of the light with the first wavelength which are perpendicular to each other, and the light with the first wavelength as the linearly polarized light into circularly polarized light. The optical path of the parallel light transmitting through the ¼ wavelength plate 150 is bent at 90°, and the parallel light enters the objective lens 170, so as to be condensed on the information recording surface of the optical disc 20. As a result, a beam spot is formed. The diffraction optical element is provided on the lens surface of the objective lens 170, and the optical power varies with wavelengths so that the spot position (optical axial direction) according to a thickness of the transparent substrate of the optical disc 20 can be obtained.

The incident light to the optical disc 20 becomes reflected light which is modulated by the information pits on the information recording surface, so as to trace the reverse optical path to that of the incident light. The reflected light is converted into linearly polarized light (polarizing direction perpendicular to the laser emitted light) by the ¼ wavelength plate 150, and is reflected by the polarization beam splitter 180. The polarization beam splitter 180 has a first reflective surface 181 and a second reflective surface 182. The first reflective surface 181 and the second reflective surface 182 are explained later. The light with the first wavelength λ1 is reflected by the first reflective surface 181. The light beams with the second and the third wavelengths λ2 and λ3 transmit through the first reflective surface 181 and are reflected by the second reflective surface 182. The light beams reflected by the polarization beam splitter 180 enter the photodetector 114 which is common between the light beams with the three wavelengths via the toric lens 190, so as to be detected as a signal.

The ¼ wavelength plate 150 gives a phase difference of 90° to the polarized light components of the light with the first wavelength which are perpendicular to each other, but gives a phase difference of 55.2° to the light with the second wavelength and a phase difference of 46.7° to the light with the third wavelength. General ¼ wavelength plates (for example, ones utilizing birefringence) serve as the ¼ wavelength plate only for a specified wavelength. Even if, therefore, the reflecting optical element which bends the optical path at 90° does not change the phase of polarized light, the light beams with the second and the third wavelengths cannot be converted from the linearly polarized light into the circularly polarized light. On the other hand, as to signal light (return path), since the ¼ wavelength plate 150 does not serve as the ¼ wavelength plate for the light beams with the second and the third wavelengths, the light which is emitted from the ¼ wavelength plate 150 does not become the linearly polarized light. As a result, an amount of light detected by the photodetector 114 is lost. Unnecessary return light enters the second or the third semiconductor laser so that the operation of the laser is made to be unstable.

The phase difference adjusting reflective film 162, which adjusts a relationship between the wavelengths and the phase differences at a predetermined incident angle, namely, generates a desired phase difference to the polarized light components of the light with predetermined wavelength, is deposited on the reflecting optical element 160 of the second embodiment. Concretely, the phase difference adjusting reflective film 162 does not generate the phase difference for the polarized light with the first wavelength, but gives the phase difference of 34.8° to the polarized light with the second wavelength and the phase difference of 43.3° to the polarized light with the third wavelength. The light reflected by the reflecting optical element 160 is converted into circularly polarized light at the first, second and third wavelengths.

On the other hand, the signal light reflected by the optical disc 120 is reflected by the reflecting optical element 160, and the above-mentioned phase differences are given to the light beams with the second and the third wavelengths. In other words, as to the light beams with different wavelengths which enter in the same polarized state (circularly polarize light) (the light beams with the first, the second and the third wavelengths) on the return path, the reflecting optical element 160 does not change the phase difference of the polarized light for the light with the first wavelength, but gives the predetermined phase differences to the light beams with the second and the third wavelengths. As a result, at any wavelengths, the light which transmits through the ¼ wavelength plate 150 in a reciprocative manner is converted into linearly polarized light which is perpendicular to the linearly polarized light on the forward path.

The first reflective surface 181 has dichromatic (long wavelength transmission type) polarized light separating characteristics such that the P polarized light with the first wavelength λ1 and the light beams with the second wavelength λ2 and the third wavelength λ3 are allowed to transmit therethrough, and the S polarized light with the first wavelength λ1 is reflected. The second reflective surface 182 has dichromatic (short wavelength transmitting type) polarized light separating characteristics such that the light with the first wavelength λ1 and the P polarized light with the second wavelength λ2 and the third wavelength λ3 are allowed to transmit therethrough, and the S polarized light with the second wavelength λ2 and the third wavelength λ3 is reflected. The second reflective surface 182 reflects the light with the second and the third wavelengths λ2 and λ3 in a position different from that of the light with the first wavelength λ1. A gap between the first reflective surface and the second reflective surface is set to be a value which is 1/\sqrt{2} as large as a gap between the light emitting position of the first light source and the light emitting positions of the second and the third light sources. As a result, the light emitting positions of the second and the third light sources are different from the light emitting position of the first light source, but the light is condensed on one position on the photodetector 114 via the toric lens 190. The first reflective surface 181 is formed on a slanted surface of a rectangular prism on the optical disc 20 side of the rectangular prisms composing the polarization beam splitter 180. This is because since a light emitting amount of the light (blue light) with the first wavelength is smaller than that of the other two colored light beams and the light with the first wavelength is absorbed by adhesive a lot, this light is prevented from transmitting through the adhesive layer.

The phase difference adjusting reflective films 62 and 162 are preferably constituted so that media which are selected from at least two groups of three groups and have the following refractive index range are combined, and these films are composed of 5 or more to 80 or less layers.
1.30<n1<1.50
1.55<n2<1.85
1.90<n3<2.60,
where,
n1 is the refractive index of the medium in the first group;
n2 is the refractive index of the medium in the second group; and
n3 is the refractive index of the medium in the third group.

When a number of the layers is less than a lower limit value, tolerance for a fluctuation in the wavelength and a fluctuation in the incident angle is eliminated, and thus the films cannot cope with the fluctuation in the wavelength and the fluctuation in the incident angle in the use state. When a number of the layers exceeds an upper limit value, the productivity is deteriorated, and the performance is easily deteriorated due to dispersion of the film thickness.

It is preferable that the incident angle θ with respect to the phase difference adjusting reflective film 62 is not less than 30° and not more than 80°. When this condition is not satisfied, the correction of the phase difference becomes difficult. It is very difficult to correct the phase difference particularly on a plurality of wavelengths.

When the phase difference adjusting reflective films 62 and 162 are not provided, the reflective surface 61a of the prism preferably satisfies total internal reflecting conditions. When the phase difference adjusting reflective films 62 and 162 are deposited on interfaces where the total internal reflecting conditions are satisfied so as to be the reflective surfaces, the high reflectance of approximately 100% can be obtained easily. Since the reflectance can be obtained due to the total internal reflection, substantially the phase difference adjusting reflective films only adjust the phase difference of the polarized light. As a result, a number of the layers of the phase difference adjusting reflective film can be reduced (for example, not more than 20 layers). The concrete constitution is explained later.

The phase difference adjusting reflective film does not have to have characteristics such that the polarized state of the incident light is not completely changed, or characteristics such that the polarized state of certain light is completely matched with the polarized state of another light. Desired characteristics of the entire optical system are only obtained. In the case of the optical pickup device, the characteristics may such that detecting signals of the photodetectors 14 and 114 do not become weak or a bad influence of the return light to the laser does not exert. Concretely, the phase difference adjusting reflective film preferably aligns the phase differences to within ±10°, more preferably ±5°. More concretely, in the case of the first embodiment, the occurrence of the phase differences due to the reflection is preferably suppressed to within ±10°, more preferably ±5°. In the case of the second embodiment, the phase differences of the light beams with the respective wavelengths after the reflection are preferably aligned so as to be within ±10°, more preferably within ±5°.

When the phase difference of not less than ±10° occurs, the signal light component is returned to the optical path on the light source side, and an S/N ratio is deteriorated and oscillation of the light sources (laser diodes) becomes unstable due to a decrease in the intensity of the signal light. When the phase difference adjusting reflective film suppresses the reflection phase difference to within ±10°, the above problems can be solved. When the reflection phase difference is suppressed to within ±5°, the effect is further improved.

The phase difference adjusting reflective film is deposited between the interface between the optically transparent medium and air and reflects the light in the medium, so that the phase difference is prevented from occurring in the polarized light components of the light with predetermined wavelength entering at a predetermined incident angle. Further, approximately 100% of the reflectance can be maintained for the light beams with plural wavelengths regardless of the fluctuation in the wavelength and in the incident angle. Further, the phase difference can be prevented for the light beams with plural wavelengths regardless of the fluctuation in the wavelength and in the incident angle.

Even if the polarized states of the light beams with plural wavelengths are different, the light beams can be reflected with reflectance of approximately 100% with the polarized states are approximately aligned.

Particularly when the interface is the total internal reflective surface, the high reflectance can be achieved and the phase differences can be adjusted easily with a small number of layers.

When the reflecting optical element having such a phase difference adjusting reflective film is used in the optical pickup device, the decrease in the signal intensity and the return light to the laser can be prevented, and the detecting accuracy of the signal is improved. Further, the optical pickup device can be thinned.

### EXAMPLES

The constitution of the reflecting optical element to be used in the optical pickup device according to the present invention is explained more concretely by exemplifying film constitution data or the like. In any examples, as shown in FIG. 2, the phase difference adjusting reflective film is deposited on the slanted surface 61a of the rectangular prism 61 whose section has a right-angled isosceles triangle shape. The incident light enters the prism perpendicularly and is totally reflected by the slanted surface 61a (incident angle is 45°). The optical path is bent at 90°, and the light is emitted from the emitting surface of the prism perpendicularly.

### Example 1

The phase difference adjusting reflective film according to the first embodiment is used, and is a multilayered film which does not change the phase difference of the incident polarized light with predetermined wavelength. The multilayered film having eighteen layers which is composed of a compound (nd=2.05) of TiO₂, SiO₂ (nd=1.46) and Al₂O₃ (nd=1.62) is deposited on the slanted surface of the prism with refractive index nd of 1.62. The refractive index nd is a refractive index with respect to d line (587.6 nm).

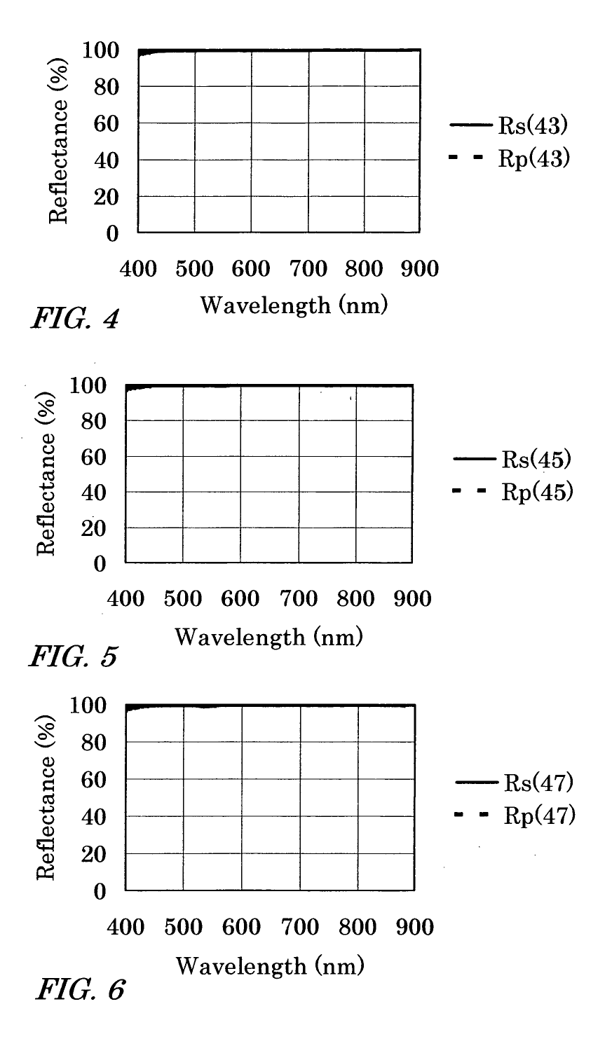

FIGS. 4, 5 and 6 illustrate reflection characteristics of the phase difference adjusting reflective film in the case where the incident angle is 43°, 45° and 47°, respectively. The wavelength (unit: nm) is read along a horizontal axis, and the reflectance (unit: %) is read along a vertical axis. A solid line represents the reflectance of the S polarized light, and a broken line represents the reflectance of the P polarized light. The reflectance is approximately 100% at any angles. For convenience of drawing the figures, only the range from 400 nm to 900 nm is illustrated, but the reflectance is not less than 95.5% on 395 nm.

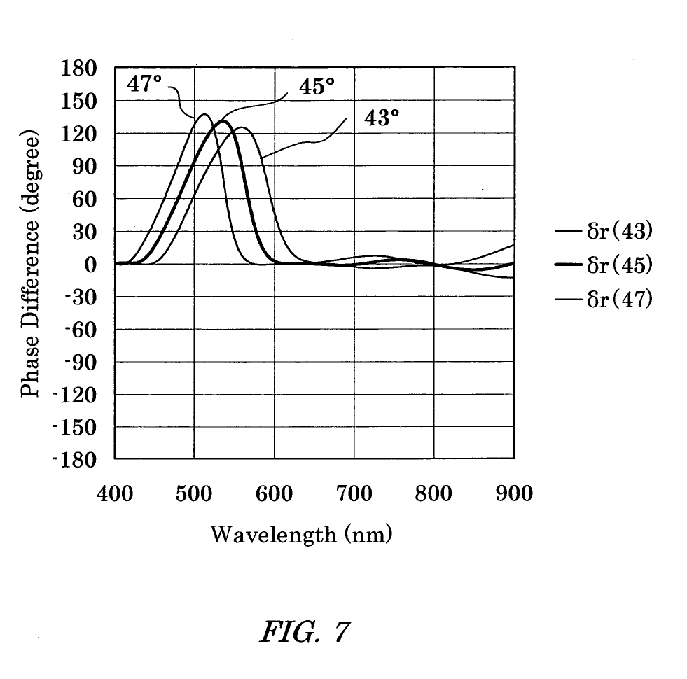

FIG. 7 illustrates the phase difference characteristics of the phase difference adjusting reflecting film in the case where the incident angle is 43°, 45° and 47°. The wavelength (unit: nm) is read along a horizontal axis, and the phase difference (unit: °) is read along a vertical axis. The phase difference is approximately 0 on the first wavelength λ1, the second wavelength λ2 and the third wavelength λ3 at any angles. For convenience of drawing the figure, only the range from 400 nm to 900 nm is illustrated, but the phase difference is suppressed to not more than 2° on 390 nm.

The film constitution of the phase difference adjusting reflective film is shown in Table 1. The film constitution is designed by the thin film designing software on the market so that the reflectance is 100% for the light near 405 nm, 630 nm and 780 nm, and the phase difference between the P polarized light and the S polarized light at the time of reflection is 0. The layer numbers in Table 1 are described starting from the prism side.

### Comparative Example

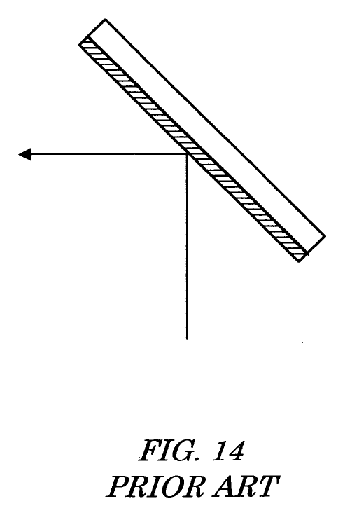

A comparative example is a surface reflective mirror having a shape shown in FIG. 14. A multilayered film having 57 layers which is composed of TiO₂ (nd=2.30) and SiO₂ (nd=1.46) is deposited on a glass surface whose refractive index nd is 1.52. The refractive index nd is an refractive index with respect to a d line (587.6 nm).

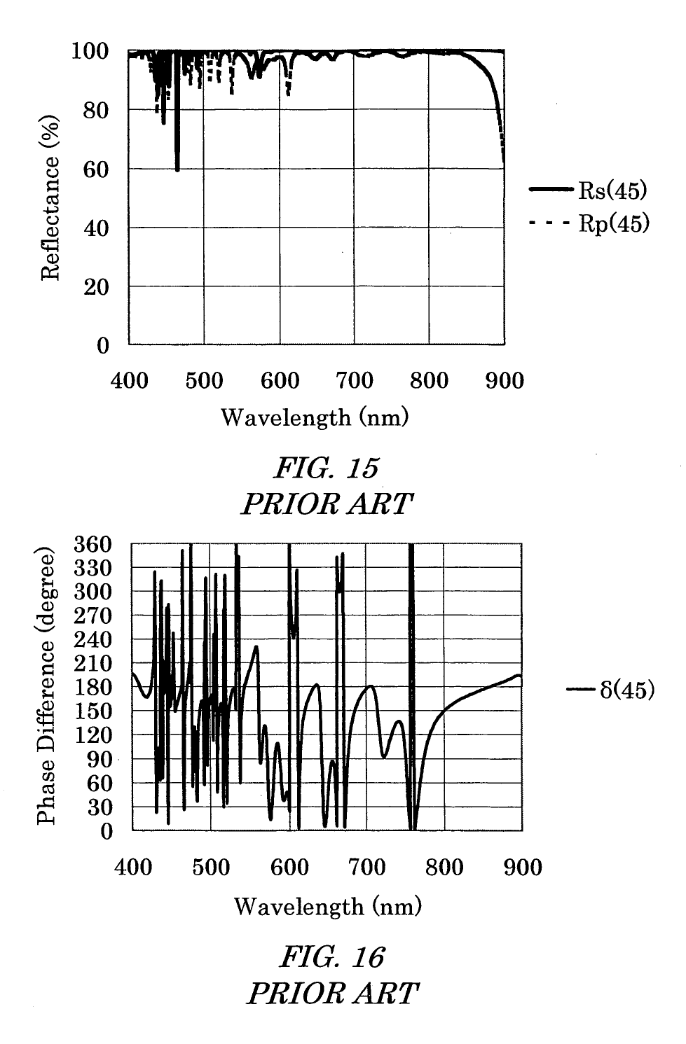

FIG. 15 illustrates reflection characteristics of the reflective film at an incident angle of 45°. The wavelength (unit: nm) is read along a horizontal axis, and the reflectance (unit: %) is read along a vertical axis. A solid line represents the reflectance of the S polarized light, and a broken line represents the reflectance of the P polarized light. The reflectance of the light beams with wavelength λ1 from the first light source, with wavelength λ2 from the second light source and with wavelength λ3 from the third light source is approximately 100%. For convenience of drawing the figure, only the range from 400 nm to 900 nm is illustrated, but the reflectance is not less than 96% on 395 nm.

FIG. 16 illustrates phase difference characteristics of the reflective film at the incident angle of 45°. The wavelength (unit: nm) is read along a horizontal axis, and the phase difference (unit: °) is read along a vertical axis. As shown in FIG. 16, even if a multilayered film having 57 layers is laminated in the surface reflective mirror, the phase difference cannot be 0 on the wavelength λ1 of the first light source, the wavelength λ2 of the second light source and the wavelength λ3 of the third light source. When the high reflectance is obtained, only the phase difference of one wavelength can be 0.

The film constitution of the comparative example is shown in Table 4. The film constitution is designed by the thin film designing software on the market so that the reflectance is 100% for the light near 405 nm, 660 nm and 780 nm, and the phase difference between the P polarized light and the S polarized light at the time of reflection is 0. The layer numbers in Table 4 are described starting from the prism side.

### Example 2

The phase difference adjusting reflective film according to the first embodiment is used, and it is a multilayered film which does not change the phase difference of the incident polarized light with predetermined wavelength at a predetermined incident angle. A multilayered film having 15 layers which is composed of Ta₂O₅, SiO₂ and Al₂O₃ is deposited on a slanted surface of the prism whose refractive index nd is 1.77.

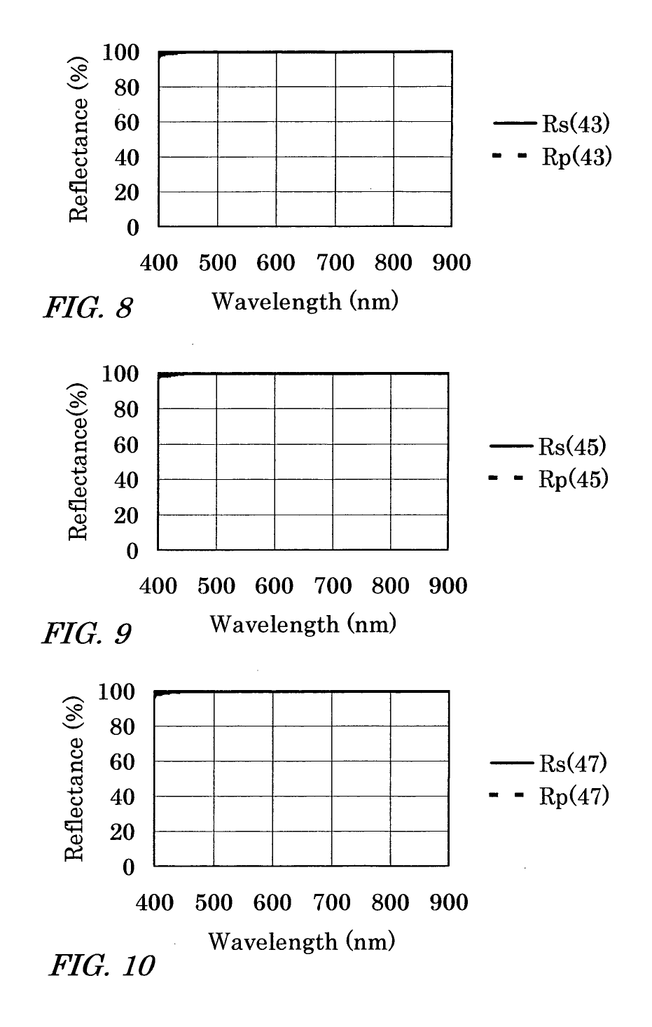

FIGS. 8, 9 and 10 illustrate reflection characteristics of the phase difference adjusting reflective film in the case where the incident angle is 43°, 45° and 47°, respectively. The wavelength (unit: nm) is read along a horizontal axis, and the reflectance (unit: %) is read along a vertical axis. A solid line represents the reflectance of the S polarized light, and a broken line represents the reflectance of the P polarized light. The reflectance is approximately 100% at any angles. For convenience of drawing the figures, only the range from 400 nm to 900 nm is is illustrated, but the reflectance is not less than 95.5% on 395 nm.

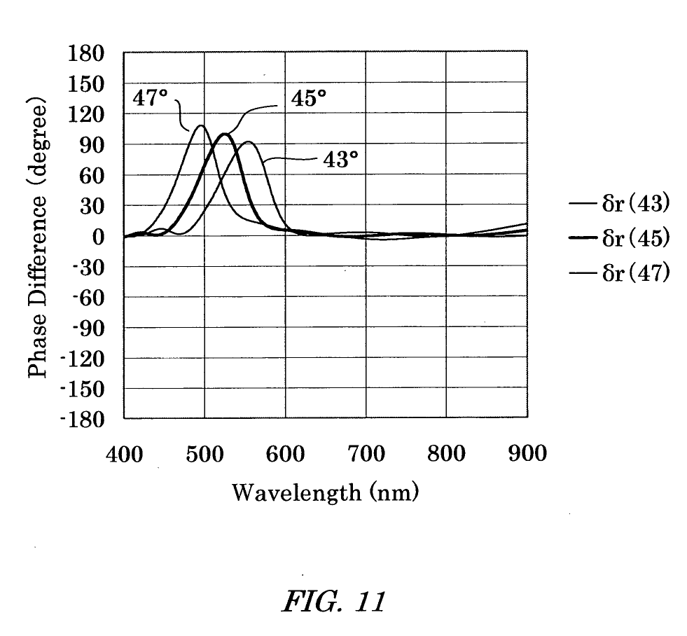

FIG. 11 illustrates the phase difference characteristics of the phase difference adjusting reflective film in the case where the incident angle is 43°, 45° and 47°. The wavelength (unit: nm) is read along a horizontal axis, and the phase difference (unit: °) is read along a vertical line. The phase difference is approximately 0 on the first wavelength λ1, the second wavelength λ2 and the third wavelength λ3 at any angles. For convenience of drawing the figure, only the range from 400 nm to 900 nm is illustrated, but the phase difference is suppressed to not more than 2° on 390 nm.

The film constitution of the phase difference adjusting reflective film is shown in Table 2. This film constitution is designed by the thin film designing software on the market so that the reflectance is 100% for the light near 405 nm, 660 nm and 780 nm, and the phase difference between the P polarized light and the S polarized light at the time of reflection is 0. The layer numbers in Table 2 are described starting from the prism side.

### Example 3

The phase difference adjusting reflective film according to the second embodiment is used, and is a film which sets the phase difference of the incident polarized light with predetermined wavelength to a desired value at a predetermined incident angle. A multilayered film having 12 layers which is composed of SiO₂ and Al₂O₃ is deposited on a slanted surface of the prism whose refractive index nd is 1.77.

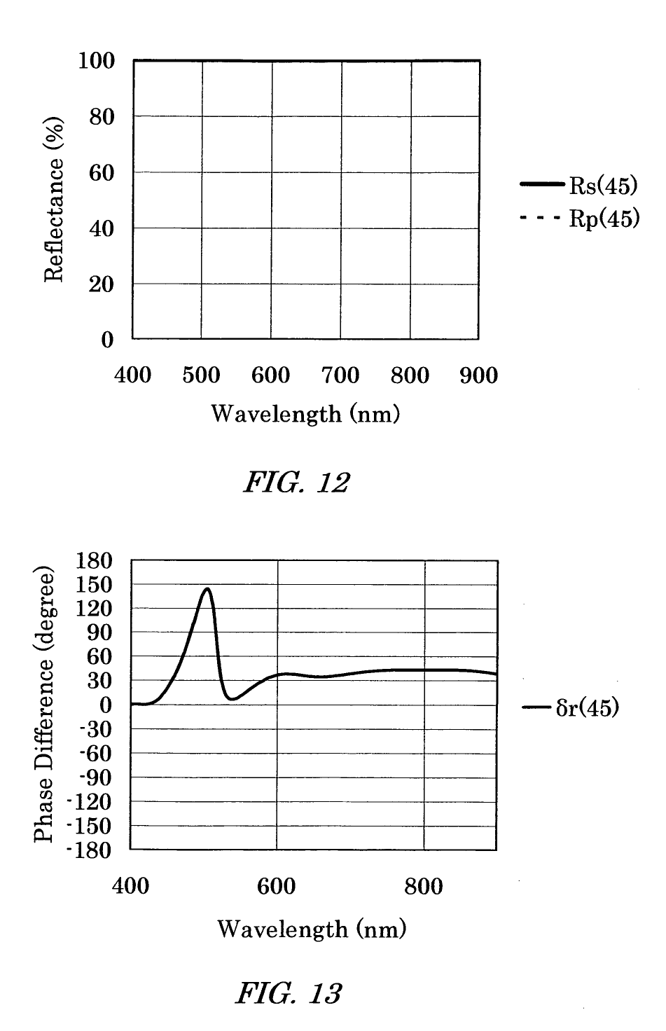

FIG. 12 illustrates reflection characteristics of the phase difference adjusting reflective film in the case where the incident angle is 45°. The wavelength (unit: nm) is read along a horizontal axis, and the reflectance (unit: %) is read along a vertical line. A solid line represents the reflectance of the S polarized light, and a broken line represents the reflectance of the P polarized light. The reflectance is approximately 100%.

FIG. 13 illustrates phase difference characteristics of the phase difference adjusting reflective film in the case where the incident angle is 45°. The wavelength (unit: nm) is read along a horizontal axis, and the phase difference (unit: °) is read along a vertical line. The phase difference on the first wavelength λ1 is 0.17°, and the phase difference on the second wavelength λ2 is 34.38°, and the phase difference on the third wavelength λ3 is 43.31°. A shortfall of the phase difference generated by the ¼ wavelength plate 150 is compensated by the phase difference adjusting reflective film. For convenience of drawing the figure, only the range from 400 nm to 900 nm is illustrated, but the phase difference is suppressed to not more than 1° on 390 nm.

The film constitution of the phase difference adjusting reflective film is shown in Table 3. This film constitution is designed by the thin film designing software on the market so that the reflectance is 100% for the light near 405 nm, 660 nm and 780 nm, and the phase difference is 0 for the light near 405 nm, 34.8° for the light near 660 nm, and 43.3° for the light near 780 nm. The layer numbers in Table 3 are described starting from the prism side.

The reflecting optical element explained in the above embodiments is a single element which bends an optical path at an angle of 90°, but the bending angle is not limited to 90°. A plurality of optical elements (for example, prisms) may be joined to the reflecting optical element. Further, the reflecting optical element may be used as the element which bends the optical path not only in the optical pickup devices but also in optical systems and optical devices utilizing polarized light.

TABLE 1
[Example 1]

| | | [Physical film |
|---|---|---|
| [Layer number] | [Material] | thickness (nm)] |
| 1 | SiO₂ | 30.88 |
| 2 | Al₂O₃ | 47.77 |
| 3 | SiO₂ | 32.74 |
| 4 | SiO₂ | 53.57 |
| 5 | Al₂O₃ | 9.11 |
| 6 | SiO₂ | 414.72 |
| 7 | Al₂O₃ | 28.79 |
| 8 | SiO₂ | 151.63 |
| 9 | Al₂O₃ | 169.36 |
| 10 | SiO₂ | 85.01 |
| 11 | Al₂O₃ | 110.51 |
| 12 | SiO₂ | 124.0 |
| 13 | Al₂O₃ | 20.15 |
| 14 | Compound of TiO₂ | 87.27 |
| 15 | Al₂O₃ | 25.55 |
| 16 | Compound of TiO₂ | 12.32 |
| 17 | Al₂O₃ | 57.96 |
| 18 | SiO₂ | 109.0 |

TABLE 2
[Example 2]

| | | [Physical film |
|---|---|---|
| [Layer number] | [Material] | thickness (nm)] |
| 1 | Al₂O₃ | 66.68 |
| 2 | Ta₂O₅ | 13.57 |
| 3 | Al₂O₃ | 165.56 |
| 4 | SiO₂ | 119.52 |
| 5 | Al₂O₃ | 31.72 |
| 6 | SiO₂ | 95.96 |
| 7 | SiO₂ | 149.33 |
| 8 | Al₂O₃ | 205.35 |
| 9 | SiO₂ | 75.06 |
| 10 | Al₂O₃ | 73.44 |
| 11 | SiO₂ | 189.56 |
| 12 | Al₂O₃ | 48.92 |
| 13 | Ta₂O₅ | 147.73 |
| 14 | Al₂O₃ | 56.11 |
| 15 | SiO₂ | 92.73 |

TABLE 3
[Example 3]

| | | [Physical film |
|---|---|---|
| [Layer number] | [Material] | thickness (nm)] |
| 1 | SiO₂ | 165.97 |
| 2 | Al₂O₃ | 238.15 |
| 3 | SiO₂ | 164.27 |
| 4 | Al₂O₃ | 77.36 |
| 5 | SiO₂ | 176.52 |
| 6 | Al₂O₃ | 179.27 |
| 7 | SiO₂ | 98.26 |
| 8 | Al₂O₃ | 71.92 |
| 9 | SiO₂ | 253.77 |
| 10 | Al₂O₃ | 40.86 |
| 11 | SiO₂ | 28.47 |
| 12 | Al₂O₃ | 164.15 |

TABLE 4
[Comparative example]

| | | [Physical film |
|---|---|---|
| [Layer number] | [Material] | thickness (nm)] |
| 1 | TiO₂ | 53.14 |
| 2 | SiO₂ | 94.22 |
| 3 | TiO₂ | 54.66 |
| 4 | SiO₂ | 100.39 |
| 5 | TiO₂ | 53.73 |
| 6 | SiO₂ | 67.36 |
| 7 | TiO₂ | 50.08 |
| 8 | SiO₂ | 97.79 |
| 9 | TiO₂ | 54.13 |
| 10 | SiO₂ | 87.24 |
| 11 | TiO₂ | 45.98 |
| 12 | SiO₂ | 94.79 |
| 13 | TiO₂ | 59.41 |
| 14 | SiO₂ | 108.41 |
| 15 | TiO₂ | 61.43 |
| 16 | SiO₂ | 146.31 |
| 17 | TiO₂ | 62.99 |
| 18 | SiO₂ | 102.13 |
| 19 | TiO₂ | 59.65 |
| 20 | SiO₂ | 122.32 |
| 21 | TiO₂ | 72.19 |
| 22 | SiO₂ | 124.14 |
| 23 | TiO₂ | 70.22 |
| 24 | SiO₂ | 120.11 |
| 25 | TiO₂ | 88.9 |
| 26 | SiO₂ | 122.56 |
| 27 | TiO₂ | 103.01 |
| 28 | SiO₂ | 124.22 |
| 29 | TiO₂ | 72.48 |
| 30 | SiO₂ | 144.67 |
| 31 | TiO₂ | 78.68 |
| 32 | SiO₂ | 125.95 |
| 33 | TiO₂ | 101.44 |
| 34 | SiO₂ | 129.54 |
| 35 | TiO₂ | 104.25 |
| 36 | SiO₂ | 119.95 |
| 37 | TiO₂ | 101.56 |
| 38 | SiO₂ | 167.94 |
| 39 | TiO₂ | 106.1 |
| 40 | SiO₂ | 113.72 |
| 41 | TiO₂ | 117.51 |
| 42 | SiO₂ | 90.07 |
| 43 | TiO₂ | 39.07 |
| 44 | SiO₂ | 240.38 |
| 45 | TiO₂ | 123.57 |
| 46 | SiO₂ | 235.95 |
| 47 | TiO₂ | 41.87 |
| 48 | SiO₂ | 234.3 |
| 49 | TiO₂ | 42.55 |
| 50 | SiO₂ | 232.73 |
| 51 | TiO₂ | 119.28 |
| 52 | SiO₂ | 82.55 |
| 53 | TiO₂ | 117.28 |
| 54 | SiO₂ | 243.22 |
| 55 | TiO₂ | 53.88 |
| 56 | SiO₂ | 249.52 |
| 57 | TiO₂ | 80.55 |

1. A reflecting optical element comprising a phase difference adjusting reflective film formed on an interface between a medium optically denser than air and air and reflecting light in the medium, wherein the phase difference adjusting reflective film reflects light having a predetermined wavelength without substantially changing a phase difference between polarized components perpendicular to each other.

2. The reflecting optical element as claimed in claim 1, wherein the medium optically denser than air is a prism having:
a first surface where light enters;
a second surface that reflects the light entering the prism; and
a third surface that emits the light,
and wherein the phase difference adjusting reflective film is formed on the second surface of the prism.

3. The reflecting optical element as claimed in claim 2, wherein the second surface of the prism satisfies a total internal reflecting condition.

4. The reflecting optical element as claimed in claim 1, wherein the phase difference adjusting reflective film is constituted so that media that are selected from at least two groups of three groups and have the following refractive index range are combined, and wherein the phase difference adjusting reflective film is composed of 5 or more to 80 or less layers,
1.30<n1<1.50
1.55<n2<1.85
1.90<n3<2.60,
where,
n1 is the refractive index of the medium in the first group;
n2 is the refractive index of the medium in the second group; and
n3 is the refractive index of the medium in the third group.

5. The reflecting optical element as claimed in claim 2, wherein the first and third surfaces have antireflective films, respectively, and wherein the first surface is perpendicular to an incident light, the third surface is perpendicular to an emitting light.

6. The reflecting optical element as claimed in claim 2, wherein the prism is a rectangular prism whose section has a right-angled isosceles triangle shape.

7. The reflecting optical element as claimed in claim 1, wherein an incident angle of the light entering the phase difference adjusting reflective film is not less than 30° and not more than 80°.

8. The reflecting optical element as claimed in claim 1, wherein the phase difference adjusting reflective film generates a phase difference within ±10°.

9. The reflecting optical element as claimed in claim 1, wherein the phase difference adjusting reflective film generates a phase difference within ±5°.

10. The reflecting optical element as claimed in claim 1, wherein an incidence light to the reflecting optical element is a circularly polarized light.

11. A reflecting optical element comprising the phase difference adjusting reflective film formed on an interface between a medium optically denser than air and air and reflecting light in the medium, wherein two or more light having different wavelengths enter the reflecting optical element, and wherein the phase difference adjusting reflective film reflects a first light with a first wavelength without substantially changing a polarized state thereof, and reflects a second light with a second wavelength so that its polarized state substantially becomes the same as the polarized state of the first light.

12. The reflecting optical element as claimed in claim 11, wherein the medium optically denser than air is a prism having:
a first surface where light enters;
a second surface that reflects the light entering the prism; and
a third surface that emits the light,
and wherein the phase difference adjusting reflective film is formed on the second surface of the prism.

13. The reflecting optical element as claimed in claim 12, wherein the second surface of the prism satisfies a total internal reflecting condition.

14. The reflecting optical element as claimed in claim 11, wherein the phase difference adjusting reflective film is constituted so that media that are selected from at least two groups of three groups and have the following refractive index range are combined, and wherein the phase difference adjusting reflective film is composed of 5 or more to 80 or less layers,
1.30<n1<1.50
1.55<n2<1.85
1.90<n3<2.60,
where,
n1 is the refractive index of the medium in the first group;
n2 is the refractive index of the medium in the second group; and
n3 is the refractive index of the medium in the third group.

15. The reflecting optical element as claimed in claim 12, wherein the first and third surfaces have antireflective films, respectively, and wherein the first surface is perpendicular to an incident light, the third surface is perpendicular to an emitting light.

16. The reflecting optical element as claimed in claim 12, wherein the prism is a rectangular prism whose section has a right-angled isosceles triangle shape.

17. The reflecting optical element as claimed in claim 11, wherein an incident angle of the light entering the phase difference adjusting reflective film is not less than 30° and not more than 80°.

18. The reflecting optical element as claimed in claim 11, wherein the phase difference adjusting reflective film generates a phase difference of the first light within ±10°.

19. The reflecting optical element as claimed in claim 11, wherein the phase difference adjusting reflective film generates a phase difference of the first light within ±5°.

20. The reflecting optical element as claimed in claim 18, wherein the phase difference adjusting reflective film reflects the second light so that a phase difference of the second light is adjusted to not more than ±10° with respect to a phase difference of the first light.

21. The reflecting optical element as claimed in claim 20, wherein the phase difference adjusting reflective film reflects the second light so that a phase difference of the second light is adjusted to not more than ±5° with respect to a phase difference of the first light.

22. The reflecting optical element as claimed in claim 18, wherein the phase difference adjusting reflective film reflects a third light having a third wavelength so that a phase difference of the third light is adjusted to not more than ±10° with respect to a phase difference of the first light.

23. The reflecting optical element as claimed in claim 18, wherein the phase difference adjusting reflective film reflects a third light having a third wavelength so that a phase difference of the third light is adjusted to not more than ±5° with respect to a phase difference of the first light.

24. An optical pickup device comprising:
a light source that emits a light; and
a reflecting optical element that reflects the light from the light source so that an optical path is bent, the reflecting optical element having a phase difference adjusting reflective film formed on an interface between a medium optically denser than air and air, the phase difference adjusting reflective film reflecting the light in the medium, wherein the phase difference adjusting reflective film reflects the light having a predetermined wavelength without substantially changing a phase difference between polarized components perpendicular to each other.

25. The optical pickup device as claimed in claim 24, wherein the medium optically denser than air is a prism having:
a first surface where the light enters;
a second surface that reflects the light entering the prism; and
a third surface that emits the light,
and wherein the phase difference adjusting reflective film is formed on the second surface of the prism.

26. The optical pickup device as claimed in claim 25, wherein the prism is a rectangular prism whose section has a right-angled isosceles triangle shape and bends an optical path by 90°.

27. The optical pickup device as claimed in claim 24, further comprising a ¼ wavelength plate disposed between the light source and the reflecting optical element, wherein a circularly polarized light enters the reflecting optical element.

28. An optical pickup device comprising:
at least two light sources emitting lights, respectively, wavelengths of the lights emitted from the light sources differing from each other;
a reflecting optical element having a phase difference adjusting reflective film formed on an interface between a medium optically denser than air and air, the phase difference adjusting reflective film reflecting the lights in the medium,
wherein the phase difference adjusting reflective film reflects a first light with a first wavelength without substantially changing a polarized state of the first light, and reflects a second light with a second wavelength so that a polarized state of the second light substantially becomes the same as the polarized state of the first light.

29. The optical pickup device as claimed in claim 28, wherein the medium optically denser than air is a prism having:
a first surface where the light enters;
a second surface that reflects the light entering the prism; and
a third surface that emits the light, and
wherein the phase difference adjusting reflective film is formed on the second surface of the prism.

30. The optical pickup device as claimed in claim 29, wherein the prism is a rectangular prism whose section has a right-angled isosceles triangle shape and bends optical paths from the light sources at 90°.

31. The optical pickup device as claimed in claim 28, further comprising a ¼ wavelength plate, disposed between the light sources and the reflecting optical element, converting the first light to a circularly polarized light,
wherein the first light of the circularly polarized light enters the reflecting optical element.

32. The optical pickup device as claimed in claim 28, wherein the light sources emit lights having wavelengths selected from at least two groups of three groups shown below,
395 nm≦λ1≦425 nm,
630 nm≦λ2≦690 nm,
740 nm≦λ3≦870 nm,
where λ1, λ2 and λ3 are wavelength of the lights emitted from the light sources.

33. An optical pickup device comprising:
a first light source emitting a first light;
a second light source emitting a second light;
a third light source emitting a third light; and
a reflecting optical element reflecting the lights from the light sources, the reflecting optical element having a prism and a phase difference adjusting reflective film, the prism having a first surface where the lights enter; a second surface including the phase difference adjusting reflective film thereon; and a third surface emitting the lights,
wherein wavelengths of the first, second and third light are different from one another, the lights having polarized states differing from one another enter the prism, and wherein the phase difference adjusting reflective film reflects any one of the first, second and third lights without substantially changing a polarized state and reflects the other two lights so that their polarized states substantially become the same as the polarized state of the light reflected without changing the polarized state.
